(19) United States
(12) Patent Application Publication
(10) Pub. No.: US 2008/0141029 A1
(43) Pub. Date: Jun. 12, 2008

(54) Digital content protection

(75) Inventor: Richard T. Culver, San Jose, CA (US)

Correspondence Address: FLIESLER MEYER LLP, 650 CALIFORNIA STREET, 14TH FLOOR, SAN FRANCISCO, CA, 94108, US

(73) Assignee: Migo Software, Inc., Redwood City, CA (US)

(21) Appl. No.: 12/001,583

(22) Filed: Dec. 11, 2007

Related U.S. Application Data
(60) Provisional application No. 60/869,518, filed on Dec. 11, 2006.

(51) Int. Cl. H04L 9/00

(52) U.S. Cl. 713/165

(57) ABSTRACT

A memory card used to store digital content can be secured by masking files in such a way that the files are not accessible via the FAT file system supplied on the card. The masking process can include pointing the directory entries for the protected file to a dummy file, removing cluster links in the file allocation table and encrypting the headers of protected files. Once inserted, an un-masking application can temporarily un-mask the protected files and initiate playback of the digital content. The un-masking process can include restoring the FAT cluster chains, directory entries and content headers on the memory card. Once the playback is initiated, the files can be immediately re-masked to protect the card in case it is removed during playback. The masking and un-masking processes can also include encrypting and storing a serial number of the memory card onto reserved sectors to prevent unwanted copying.

### CLAIM OF PRIORITY

This application claims priority to U.S. Provisional Patent Application No. 60/869,518 entitled “DIGITAL CONTENT PROTECTION” by Richard T. Culver, filed Dec. 11, 2006, the entire contents of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to digital content protection and more particularly to systems and methods that facilitate protection of digital content on secured digital (SD) and multimedia cards (MMC) via file allocation table (FAT) modifications.

### BACKGROUND

Secured Digital (SD) and multimedia cards (MMC) are used to provide and store digital content to and from portable devices. Because of the music industry concerns that MMC cards would allow for easy piracy of music, the SD was created by adding encryption hardware to MMC cards to allow enforcement of digital rights management (DRM) schemes on digital music. Since such implementations can be reverse engineered, they are generally not effective and, thus, are rarely used.

Thus, it is desirable to provide systems and methods that facilitate effective protection of digital content on SD and MMC cards.

### BRIEF DESCRIPTION OF THE DRAWINGS

FIG. 1 provides an illustration of a FAT file system layout, in accordance with various embodiments.

FIG. 2 provides an illustration of a FAT fragment first showing unprotected content and the showing protected content, in accordance with various embodiments.

FIG. 3 is a flow chart illustration of a masking process for protecting the digital content on a card, in accordance with various embodiments.

FIG. 4 is a flow chart illustration of a process to unmask the protected content, in accordance with various embodiments.

FIG. 5 is a flow chart illustration of a process to unmask the protected content once the serial numbers are determined to match, in accordance with various embodiments.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details will be set forth to provide a thorough description of the invention. However, it will be apparent to those skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device or appliance. Furthermore, it can also be apparent to those skilled in the art that such components, regardless of how they are combined or divided, can execute on the same computing device or can be distributed among different computing devices connected by one or more networks or other suitable communication means.

The various embodiments described in the present disclosure are directed to a novel and effective technique for hiding and protecting digital content on SD/MMC cards. Unlike other digital rights management (DRM) techniques, which rely on data encryption/decryption methods to protect content, the disclosed method can hide un-encrypted content files on the card in such a way that they are not visible or accessible via the FAT file system supplied on the card until they are enabled by an unlocking process. The general file allocation table (FAT) file system is well known in the art. As an example, a detailed discussion of the FAT file system is provided at http://hoine.freeuk.net/foxy2k/disk/disk1.htm and incorporated herein by reference.

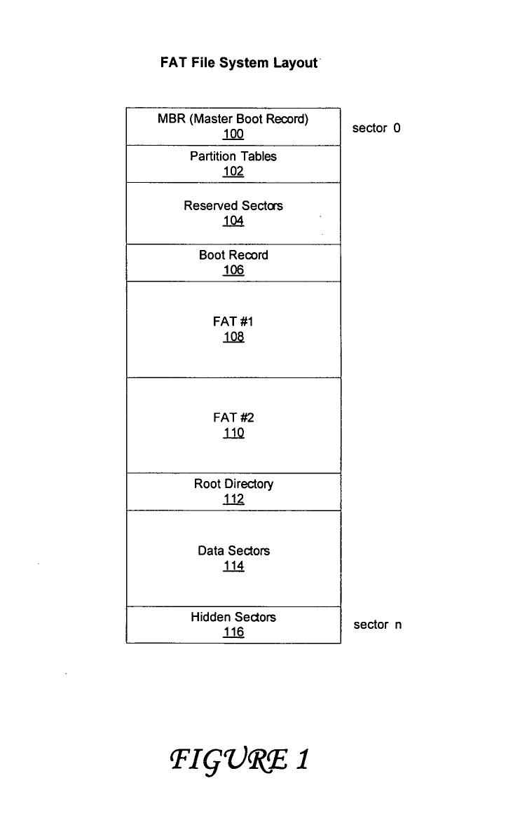

While all of the protected content physically resides in the “Data Area” of the card or disk, the size and location of each protected file remains masked until enabled for play back. Since normal access to files is through the FAT file system (a typical FAT file system layout on a card is illustrated in FIG. 1), if a file is not listed or found in any directory on the card, it cannot normally be played or accessed for copying. There are commercially available programs that ignore the FAT file system and search for media content sector-by-sector in an effort to restore lost or deleted files, but these generally fail if the media file headers cannot be found. In the method described herein, the headers of all protected media files can be removed to prevent discovery by file restoring programs.

To enable play back, the original directory entries, the FAT cluster links, and the file headers can be restored to the FAT file system on the protected card. As noted above, the information used to do this is stored in reserved sectors on the card outside of the Data Area. Reserved sectors are not accessible through the FAT file system and other techniques are generally used to read them. The background process of the unmasking application is able to read them and restore the FAT file system thus exposing the size and location of all protected content files. This can be done in real time just prior to actual play back.

Reading the reserved sectors (or any sector) can be implemented with a low level driver routine available from Microsoft Corporation, by providing the starting location of the physical sector to be read, the number of bytes to be read, and a buffer name to receive the data. The location and number of reserved sectors can be determined by the formatting routine used to format the card.

Once a sector has been read, the buffer data can be written to any sector using the same low level driver routines. Preferably, the data is written to the known sectors in the FAT, file directory, or file headers that were modified during the protection process.

Normal copy operations do not copy the reserved sectors, so any copies made of the original card will generally not have the required data to enable play back. There are programs available, though, that can copy entire disk images and not just the files listed in the FAT file system. Cards built from disk image files will contain the protected content files, however, the unmasking application or background process will NOT restore them to the FAT file system if requested by the user.

Every SD or MMC card is assigned a unique serial number during the manufacturing process and is embedded within the card's controller. Since this serial number is not stored in the flash area, it is not normally accessible to the user. To build a protected card, the card's unique serial number is read, encrypted, and then hidden in the reserved sector area of the card. If a new card is built with the disk image from a protected card, the new card's unique serial number will not match the encrypted serial number hidden in the reserved sector area, and background process or unmasking application will refuse to restore the original directory entries, FAT cluster links, and file headers needed to unlock the card's protected files.

Notably, a card's FAT system is cached in local memory on the play back device when a card is first inserted. In certain embodiments, any modifications made on-the-fly to a card's FAT file system will not be visible to the play back device until it refreshes its cache. This normally only happens when a card is re-inserted, but software can also be used to force the device to refresh its cache. This component of the preferred protection scheme allows the protected files to be momentarily restored to the card's FAT file system, update the device's cache with this new information, and then IMMEDIATELY re-mask the protected files on the card. The device continues working with the FAT snapshot just provided and is unaware of the re-masking step. This is advantageous because it can keep the content files on the card in a protected state except for the brief moment used to reveal their presence to the play back device. In this embodiment, even if the card is removed during play back, the protected files will not be visible on the card.

If playback is terminated for any reason, the background process forces the device to update its cached FAT image of the card. Since the card has already masked and protected the content files, the device no longer knows where they are located.

This process can be repeated each time a playback request is made. In one embodiment, at no time is the protected content copied to the play back device. In this embodiment, play back can only be from the card itself—and only if the card's unique serial number matches the one encrypted and hidden in the reserved sector area.

In various embodiments, the masking process involves three different techniques or layers:

1. The directory entry for each protected file points to a dummy error message file rather than the original content file and the file size reported is that of the dummy file.

2. The protected file's cluster links in the FAT (File Allocation Table) are removed and replaced with a code representing “bad cluster.”

3. The headers of all protected files are encrypted.

FIG. 1 provides an illustration of a FAT file system layout, in accordance with various embodiments. Although this diagram depicts components as logically separate, such depiction is merely for illustrative purposes. It will be apparent to those skilled in the art that the components portrayed in this figure can be arbitrarily combined or divided into separate components or storage spaces. Furthermore, it will also be apparent to those skilled in the art that such components, regardless of how they are combined or divided, can be read on the same computing device or can be distributed among different computing devices connected by one or more networks or other suitable communication mediums.

As illustrated, a typical FAT file system layout is divided into multiple sectors 0-n. In one embodiment, sector 0 contains the Master Boot Record (MBR) 100. The MBR 100 is a section of a disk drive's (or memory card's) storage space that is set aside for the purpose of saving information necessary to begin the bootstrap process. The next sector contains the partition tables 102 which contains information of how many and which types of partitions are on disk. The next section of the layout includes a set of reserved sectors 104. The reserved sectors 104 are generally not accessible through the FAT file system and other techniques are typically used to read them.

In various embodiments, the layout includes a boot record 106, followed by one or more file allocation tables (FAT) such as FAT #1 108 and FAT #2 110. In one embodiment, these are file system tables used by the FAT-file systems and contain information about where on the disk the content of the files are stored.

As illustrated, the layout includes a root directory 112, which is a topmost directory in the hierarchy of all sub-directories, followed by a number of data sectors 114. In various embodiments, the FAT file system layout can also include hidden sectors 116.

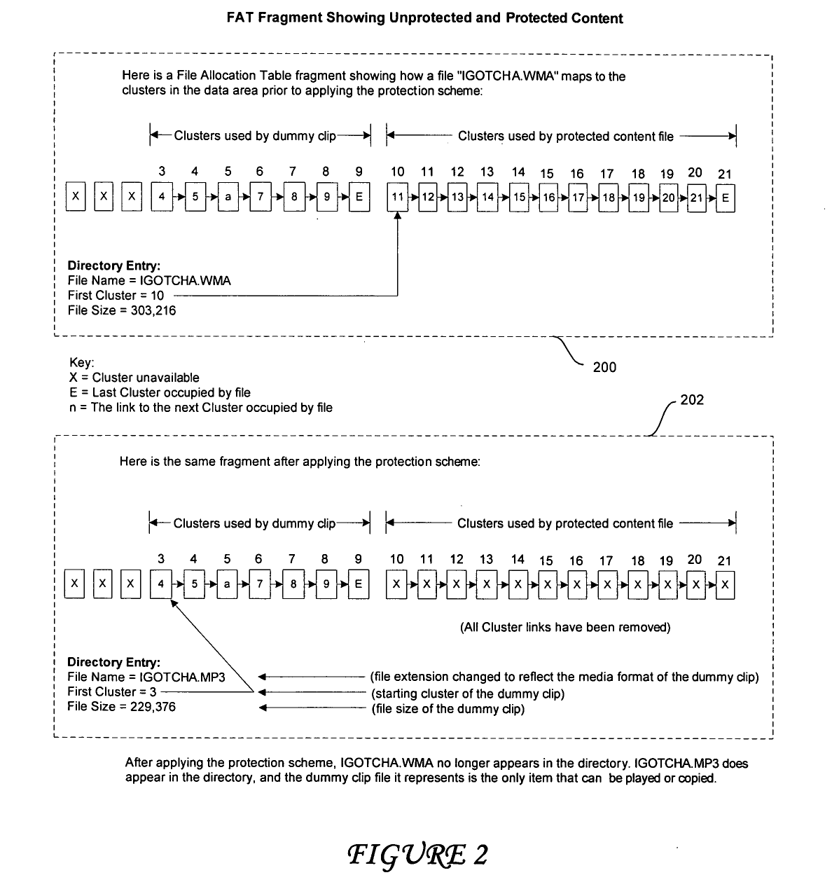

FIG. 2 provides an illustration of a FAT fragment first showing unprotected content and then showing protected content, in accordance with various embodiments. Although this diagram depicts components as logically separate, such depiction is merely for illustrative purposes. It will be apparent to those skilled in the art that the components portrayed in this figure can be arbitrarily combined or divided into separate software, firrnware and/or hardware. Furthermore, it will also be apparent to those skilled in the art that such components, regardless of how they are combined or divided, can execute on the same computing device or can be distributed among different computing devices connected by one or more networks or other suitable communication mediums.

In FIG. 2, the clusters are shown before applying the content protection scheme (masking process) 200 and after applying the protection scheme 202. The clusters used by a dummy clip are clusters 0-9 and clusters used by the protected content file are 10-21. After applying the protection scheme discussed in the present disclosure, the clusters used by protected content file are masked, removing all cluster links. The file extension of the protected file can be changed to reflect the media format of the dummy clip. Thus, after applying the masking process, the protected content file “IGOTCHA.WMA” no longer appears in the directory and in its place, a dummy file “IGOTCHA.MP3” appears in the directory. This dummy clip file represents the only item that can be played or copied. Similarly, the file size of the dummy clip is reported instead of the actual size of the protected content file.

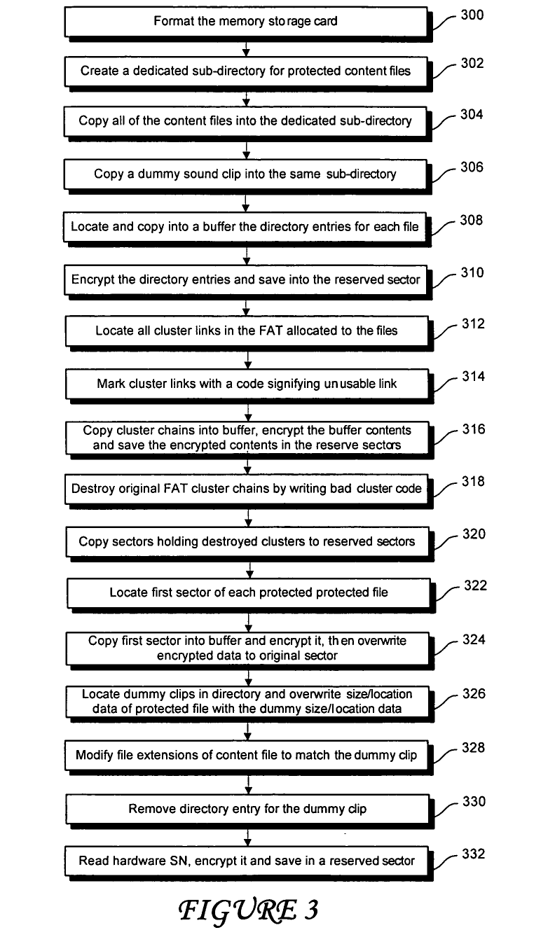

FIG. 3 is a flow chart illustration of a masking process for protecting the digital content on a card, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

In various embodiments, the steps to build a protected card and accomplish processes 1 through 3 above can be as follows:

According to the process, the card is first freshly formatted (Step 300). This is a preferable step to locate all of the protected content files very near the front of the FAT, adjacent to each other and not spread out with unrelated files sitting between them. Next, a dedicated sub-directory is created for protected content files (Step 302). All of the content files to be protected are copied to the dedicated sub-directory (Step 304). A dummy sound clip(s) is then copied to the same sub-directory used for protected content (Step 306). This could be one clip if only an audio error message is intended to be played, or multiple clips if samples of the protected content are intended to be played. The content samples could include information about purchasing the full content file.

At this point, the content files are not protected and can be seen and used by any system reading the card. This is the unmasked state of the card, the FAT, the directories, and the content files. In order to protect the content on the card, a protection process must be performed. While steps 300 through 306 above use standard Microsoft tools controlled manually with an operators keyboard and/or mouse inputs, the protection process steps can utilize Microsoft routines, including non-standard routines that are run or called from an application, e.g., applicant's disk protector application written in C++. In one embodiment, when run, the application performs the following steps:

First, the directory entries for each file to be protected is located and copied to a buffer (Step 308). The directory entries in the buffer are then encrypted and saved in a reserved sector of the card (Step 310). The number of reserved sectors is determined during the card formatting process and remains constant. The formatting process preferably provides all the reserved sectors needed to support the content protection scheme.

Using the directory entry information as a starting point, all of the cluster links in the FAT (File Allocation Table) allocated to the files being protected can be located (Step 312). These clusters links form cluster chains, and each file is assigned its own cluster chain. Cluster chains are merely a series of cluster links with each cluster link pointing to the next cluster link in the chain. The last cluster link is marked with a code signifying the end of the cluster chain. FIG. 1 shows an example of a cluster chain in unmasked and masked states. Note: a cluster is defined to be from 1 to 64 data sectors. The actual number of sectors used per cluster is determined during the formatting process and remains constant.

To simplify FAT cluster chain masking and unmasking, full sectors (512 bytes) can preferably be used. To prevent a user from adding any new file cluster chains to the sectors holding the masked cluster chains, any unused cluster links in the FAT cluster chain sectors can be marked with a code signifying that the data cluster is bad and unusable (Step 314). As a result, the user can add and delete files at will without disturbing the content protection scheme, and without risking destruction of the cluster chains associated with the user's files.

Next, all of the sectors holding the cluster chains identified above are copied to a buffer. The buffer contents are then encrypted and the encrypted contents are saved in reserved sectors (Step 316). The original FAT cluster chains are then destroyed by writing the bad cluster code to each cluster link (Step 318) and all of the sectors holding the destroyed cluster chains are copied to reserved sectors (Step 320). Saving both images of the modified FAT sectors (Steps 310 and 320) allows for quick unmasking and re-masking of the protected contents'FAT clusters chains by simply copying the reserved sectors and pasting them into the FAT. In one embodiment, the valid cluster chains are encrypted and must be decrypted prior to the pasting. This can be an additional step, but it generally does not cause significant latency to the user experience.

Next, the first sector of each protected content file in the Data Area of the card is located using the directory information (Step 322). These sectors will contain the content headers, which will be encrypted. The first sector of each protected content file is then copied into a buffer and encrypted, and then the encrypted data is overwritten to the original sector (Step 324). Alternatively, a reserved sector could be used to save the file's encrypted sector, with the original sector filled with 0's.

In one embodiment, a list of all reserved sectors used is maintained in order to later retrieve and restore the file headers (first data sector), FAT cluster chains, and directory entries data.

The dummy clip(s) in the directory are located (Step 326) and the location and size information of the dummy clip(s) found there are used to overwrite the directory location and size information for each protected content file. The protected content file directory entries should now point to the dummy clip(s). If the media types of the protected content files are different than the dummy clip(s), as determined by the file extensions used, the file extensions (e.g.WMA, WMV, .MP3, etc) of the protected content files are changed to match the dummy clip(s) (Step 328). The directory entry for the dummy clip(s) is then removed (Step 330). The user preferably does not see this information when the user lists the contents of the directory.

Next, a copy of the just modified directory entries is saved in a reserved sector for later use. The card's hardware serial number (SN) is then read from the internal state machine controller. The machine controller resides on the card and is used to interface the internal flash memory to the outside world and control all read, write, and erase operations. The SN is then encrypted and saved in a reserved sector (Step 332) to complete the protection or masking process.

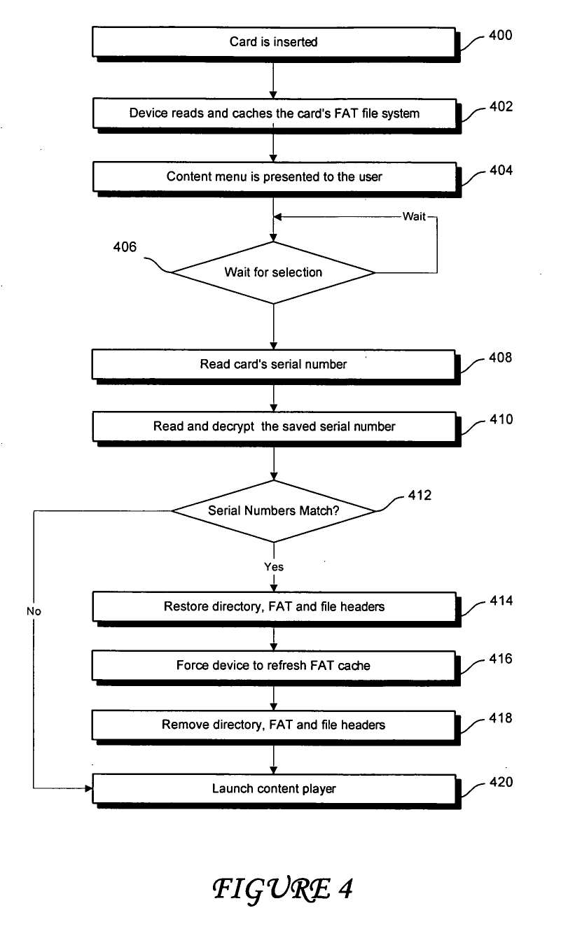

With the protection or masking process complete, all sub-directories and supporting applications files can be added to complete the card. The card then can be used by the user, but the protected content will not be visible unless the user accesses it with an unmasking application described below in conjunction with FIG. 4.

Users can be supplied with a card or cards, SD or MMC, containing protected content, a menu system for selecting content for playback, and a resident program, i.e., an unmasking application, to validate the card and control access to protected content.

In one embodiment, when a card is inserted into a supported playback platform, a menu is presented to the user allowing them to select individual content for playback. Playback of the selected item begins immediately after the user's selection unless the card is an unauthorized copy. Unauthorized copies will only playback a pre-recorded error message or samples of the protected content; not the original content.

In one embodiment, inserting the card into an unsupported platform will not bring up the playback menu. In that case, if the user attempts to launch playback by manually selecting content on the card, only the prerecorded error message will be heard. This can also be true for a supported platform if the user attempts to launch playback manually. In one embodiment, playback can only be initiated through a preferred menu system and unmasking application. Further, users will typically find that they are unable to copy protected content from the card to any other device including a backup card.

In various embodiments, validating the card and enabling content is performed in the background just prior to play back. In one embodiment, the user is unaware of these background processes, and since they occur prior to play back and not during, the player requires no special codecs—i.e., device or program capable of performing encoding and decoding on a digital data stream or signal—and no additional processing power. Any player capable of viewing or listening to the media type can work.

FIG. 4 is a flow chart illustration of a process to unmask the protected content, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

In one embodiment, the unmasking application includes the following steps (illustrated in part in FIG. 4):

After the user inserts a card into the player (Step 400), the player or device reads and cashes the card's FAT file system (Step 402). The content menu is then presented to the user (Step 404) and the program waits (Step 406) for the user's selection. Once the user makes a selection, the card's serial number is read (Step 408) and the serial number hidden in a reserved sector on the card is read and decrypted (Step 410). The card's serial number and the saved encrypted serial numbers are compared to see if they match (Step 412). If the serial numbers do not match, the player is immediately launched using the dummy clip as the playback target (Step 420) and then stopped.

If the serial numbers match, the directory entries, FAT and file headers are restored (Step 414) as will be discussed in further detail below. Subsequently, the device is forced to refresh its FAT cache (Step 416), and then the directory entries, FAT and the file headers can be again removed (Step 418). Thus, if the serial numbers match, the content player can play the protected content in the FAT cache on the device.

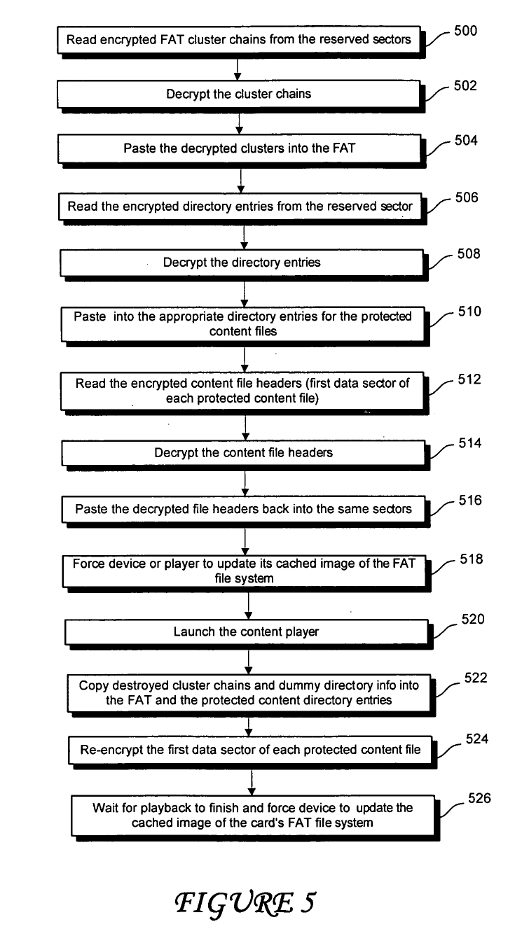

FIG. 5 is a flow chart illustration of a process to unmask the protected content once the serial numbers are determined to match, in accordance with various embodiments. Although this figure depicts functional steps in a particular sequence for purposes of illustration, the process is not necessarily limited to this particular order or steps. One skilled in the art will appreciate that the various steps portrayed in this figure can be changed, rearranged, performed in parallel or adapted in various ways. Furthermore, it is to be understood that certain steps or sequences of steps can be added to or omitted from this process, without departing from the spirit and scope of the invention.

If the serial numbers match, the encrypted FAT cluster chains are read from the reserved sectors (Step 500), decrypted (Step 502), and pasted into the FAT (Step 504). In one embodiment, there are preferably two copies of the FAT. One is the primary FAT and the other is a backup FAT. The backup FAT is preferably never used, but is always keep in sync with the primary FAT. Any changes made to the primary FAT will also be duplicated in the backup FAT.

Next, the encrypted directory entries are read from the reserved sector (Step 506), decrypted (Step 508), and pasted into the appropriate directory entries for the protected content files (Step 510). The encrypted content file headers (the first data sector of each protected content file) is then read (Step 512), decrypted (Step 514), and pasted back into the same sectors (Step 516). The device or player is then forced to update its cached image of the card's FAT file system (Step 518).

The player is then launched using the selected content file name as the target for playback (Step 520). Next, all of the destroyed cluster chains and dummy directory info from the reserved sectors are copied and pasted into the FAT and the protected content directory entries (Step 522). The first data sector of each protected content file is re-encrypted (Step 524).

The application then waits for playback to finish (either user terminated or end of content reached). The card, however, is currently in the masked (protected) state again. In one embodiment, if the user pulls the card during playback, they will not be able to use it to retrieve the protected content files.

The device is forced to update its cached image of the card's FAT files system (Step 526). The protected content files will no longer be visible to the device as the card has already been protected during steps 522 and 524 above. In one embodiment, steps 500 through 524 will be repeated when the user selects another content file for playback.

Various embodiments of the invention previously described include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information.

Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations can be apparent to the practitioner skilled in the art. Embodiments were chosen and described in order to best explain the principles of the invention and its practical application, thereby enabling others skilled in the relevant art to understand the invention. It is intended that the scope of the invention be defined by the following claims and their equivalents.

What is claimed is:

1. A method for protecting digital content on a storage medium, said method comprising:
masking one or more digital content files on the storage medium such that the one or more digital content files cannot be accessed by file allocation table (FAT) file system standard operations;
temporarily un-masking the one or more digital content files to be accessible via the FAT file system for content playback;
initiating playback of the one or more digital content files by a content player once said digital content files are un-masked; and
immediately re-masking the one or more digital content files following initiation of the playback such that the one or more digital content files are in a masked state on the storage medium during the playback of the one or more digital content files by the content player.

2. The method of claim 1 wherein masking the one or more digital content files further includes:
referencing a directory entry for each digital content file to a dummy error message file instead of the digital content file; and
reporting the file size of the dummy file.

3. The method of claim 1 wherein masking the one or more digital content files further includes:
removing one or more cluster links of the digital content files in the file allocation table (FAT); and
replacing the one or more cluster links with a code representing an unusable cluster.

4. The method of claim 1 wherein masking the one or more digital content files further includes:
encrypting content headers of each digital content file.

5. The method of claim 1 wherein masking the one or more digital content files further includes:
reading a hardware serial number of the storage medium;
encrypting the hardware serial number; and
storing the hardware serial number of the storage medium into a reserved cluster outside of data sector of the storage medium.

6. The method of claim 1 wherein temporarily unmasking the one or more digital content files further includes:
reading a first hardware serial number of the storage medium;
reading a second hardware serial number stored in a reserved cluster outside of the data sector of the storage medium;
comparing the first hardware serial number and the second hardware serial number; and
temporarily un-masking the one or more digital content files only if the first hardware serial number matches the second hardware serial number.

7. The method of claim 1 wherein temporarily un-masking the one or more digital content files further includes:
restoring the FAT cluster chains, directory entries and content headers on the storage medium.

8. The method of claim 1 wherein immediately re-masking the one or more digital content files further includes:
copying a set of destroyed cluster links and dummy directory information into the FAT.

9. The method of claim 1, further comprising:
waiting for the playback of the one or more digital content files to complete; and
forcing a refresh of the cached image of the storage medium's FAT file system.

10. The method of claim 1 wherein the storage medium is at least one of: a disk, a card, a Secured Digital (SD) card, and a multimedia card (MMC).

11. A system for protecting digital content on a storage medium, said system comprising:
a memory card containing one or more digital content files, said digital content files having been masked such that the digital content files cannot be accessed by file allocation table (FAT) file system standard operations; and
a device connectable to the memory card, said device containing a content player for conducting playback of the one or more digital content files;
wherein upon connecting the memory card to the device, the digital content files are temporarily un-masked to be accessible via the FAT file system for content playback and immediately re-masked following initiation of the content playback such that the digital content files remain in the masked state during the remainder of the content playback.

12. The system of claim 11 wherein masking the one or more digital content files further includes:
referencing a directory entry for each digital content file to a dummy error message file instead of the digital content file; and
reporting the file size of the dummy file.

13. The system of claim 11 wherein masking the one or more digital content files further includes:
removing one or more cluster links of the digital content files in the file allocation table (FAT); and
replacing the one or more cluster links with a code representing an unusable cluster.

14. The system of claim 11 wherein masking the one or more digital content files further includes:
encrypting content headers of each digital content file.

15. The system of claim 11 wherein masking the one or more digital content files further includes:
reading a hardware serial number of the memory card;
encrypting the hardware serial number; and
storing the hardware serial number of the memory card into a reserved cluster outside of data sector of the memory card.

16. The system of claim 11 wherein temporarily un-masking the one or more digital content files further includes:
reading a first hardware serial number of the memory card;
reading a second hardware serial number stored in a reserved cluster outside of the data sector of the memory card;
comparing the first hardware serial number and the second hardware serial number; and
temporarily un-masking the one or more digital content files only if the first hardware serial number matches the second hardware serial number.

17. The system of claim 11 wherein temporarily un-masking the one or more digital content files further includes:
restoring the FAT cluster chains, directory entries and content headers on the memory card.

18. The system of claim 11 wherein immediately re-masking the one or more digital content files further includes:
copying a set of destroyed cluster links and dummy directory information into the FAT.

19. The system of claim 11, wherein the memory card includes an un-masking application stored thereon, which is executed upon connecting the memory card to the device, said masking application performing the temporary un-masking and re-masking of the digital content files.

20. A computer readable medium carrying one or more sequences of instructions for providing digital content protection, which instructions, when executed by one or more processors, cause the one or more processors to carry out the steps of:
masking one or more digital content files on the storage medium such that the one or more digital content files cannot be accessed by file allocation table (FAT) file system standard operations;
temporarily un-masking the one or more digital content files to be accessible via the FAT file system for content playback;
initiating playback of the one or more digital content files by a content player once said digital content files are un-masked; and
immediately re-masking the one or more digital content files following initiation of the playback such that the one or more digital content files are in a masked state on the storage medium during the playback of the one or more digital content files by the content player.
